(19) United States
(12) Patent Application Publication
(10) Pub. No.: US 2009/0276752 A1
(43) Pub. Date: Nov. 5, 2009

(54) METHOD FOR COMMUNICATING COLLABORATIVE SOFTWARE DEVELOPMENT INFORMATION

(75) Inventor: Sanjeev Sharma, Ashburn, VA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/112,486

(22) Filed: Apr. 30, 2008

(51) Int. Cl. G06F 9/44

(52) U.S. Cl. 717/103

(57) ABSTRACT

A method for communicating collaborative software development information including receiving a development of a software code via an integrated development environment (“IDE”) from one of a plurality of collaborative software developers, receiving information about the development of the software code via the IDE, storing the information on the storage device via the IDE, whereby the information is accessible from the storage device together with the development and the software code, indicating the development of the software code by emphasizing the development through modifying the software code text from a normal format, indicating an availability of the information about the development by providing a selectable indicator in proximity to the indicated development that includes a selectable icon or hyperlink added to the software code, presenting the information to the other of the collaborative software developers in response to the developer selecting the selectable indicator while reviewing the development via the IDE.

### BACKGROUND OF THE INVENTION

1. Field of the Invention

This invention relates generally to software development, and particularly to a method for communicating collaborative software development information.

2. Description of Background

As businesses become more geographically distributed with locations throughout the world, their operations may be conducted collectivity (e.g., for a common purpose, project, product, etc.) at these various locations in a collaborative manner (e.g., through the combined efforts of multiple employees, teams, departments, etc.). Computer software development is a pertinent example of such collaborative business operations. For example, software developers may work on the development of the same computer software (program, code, file, etc.) collaboratively from various locations across the world at different relative times in a daily period due to their locations in different time zones. Therefore, when a developer works on the development of the software in one location, there is a need to communicate information about that development to collaborating developers at other locations that may be in time zones that are, e.g., 8 to 12 hours different in time from that of the location of the originating developer.

Some approaches to communicate information about the software development use phone calls (e.g., conference calls) or instant messages (e.g., via computers, cell phones, etc.). However, such approaches may be useful during limited periods of normal work hours, or not at all, depending on the time zone differences of the locations of the collaborating developers. Other approaches to communicate information about the software development use email or voicemail messages. However, such approaches tend to separate the information about the development from the software (e.g., from the lines of software code, which may be in multiple files), thereby making it necessary for the collaborating developers to determine and/or locate the software code that is referred to in the messages and making it difficult to audit the compliance of the software code (e.g., regarding design standards, specifications, etc.). Furthermore, such approaches do not provide a way to connect the messages to the software code, e.g., within an integrated development environment (IDE—such as a software development computer program) and to, thereby, store the messages in a software code warehouse or repository (e.g., within a computer system). Therefore, an approach is desirable for communicating collaborative software development information that avoids such issues of inconvenience, impracticability, compliance, etc. and allows information about software development to be connected to the software code.

### SUMMARY OF THE INVENTION

A method for communicating collaborative software development information is provided. An exemplary embodiment of the method includes receiving a development of a software code via an integrated development environment (“IDE”) executed on a computing device from one of a plurality of collaborative software developers located at a plurality of locations, wherein the software code is accessible via the IDE by the plurality of collaborative software developers, receiving information about the development of the software code via the IDE that includes an audio message, a video message, or graphical data related to the development, storing the information on the storage device via the IDE, whereby the information is accessible from the storage device together with the development and the software code via the IDE by an other of the plurality of collaborative software developers, indicating the development of the software code by emphasizing the development through bolding, coloring, highlighting, or modifying the software code text from a normal format, indicating an availability of the information about the development by providing a selectable indicator in a proximity to the indicated development that includes a selectable icon or hyperlink added to the software code that causes the information to be presented when selected, presenting the information to the other of the collaborative software developers in response to the developer selecting the selectable indicator while reviewing the development via the IDE.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a computer system including an exemplary computing device configured for communicating collaborative software development information.

FIG. 2 is a block diagram illustrating an example of a subsystem of the exemplary computer system of FIG. 1 that is configured for communicating collaborative software development information.

FIG. 3 is a flow diagram illustrating an example of a method for communicating collaborative software development information, which is executable, for example, on the exemplary computing device of FIG. 1.

The detailed description explains the preferred embodiments of the invention, together with advantages and features, by way of example with reference to the drawings.

### DETAILED DESCRIPTION OF THE INVENTION

According to exemplary embodiments of the invention described herein, a method for communicating collaborative software development information is provided. In accordance with such exemplary embodiments, an approach is provided for communicating collaborative software development information that avoids issues of inconvenience, impracticability, compliance, etc. and allows information about software development to be connected to the software code, e.g., in the form of messages (e.g., audio, video, etc.) and graphics (e.g., diagrams, drawings, etc.), e.g., within an integrated development environment (“IDE”). Other benefits of the approach include avoiding confusion about which developments (e.g., modifications, testing, etc.) of software code correspond to the collaborative software development information, allowing developers to review previous activities about the development of software code, and providing a complete audit trail for compliance purposes stored within one system that is accessible via an IDE. Furthermore, the approach allows information about developed software code to be accessed via various configurations of IDEs together with the developed software code.

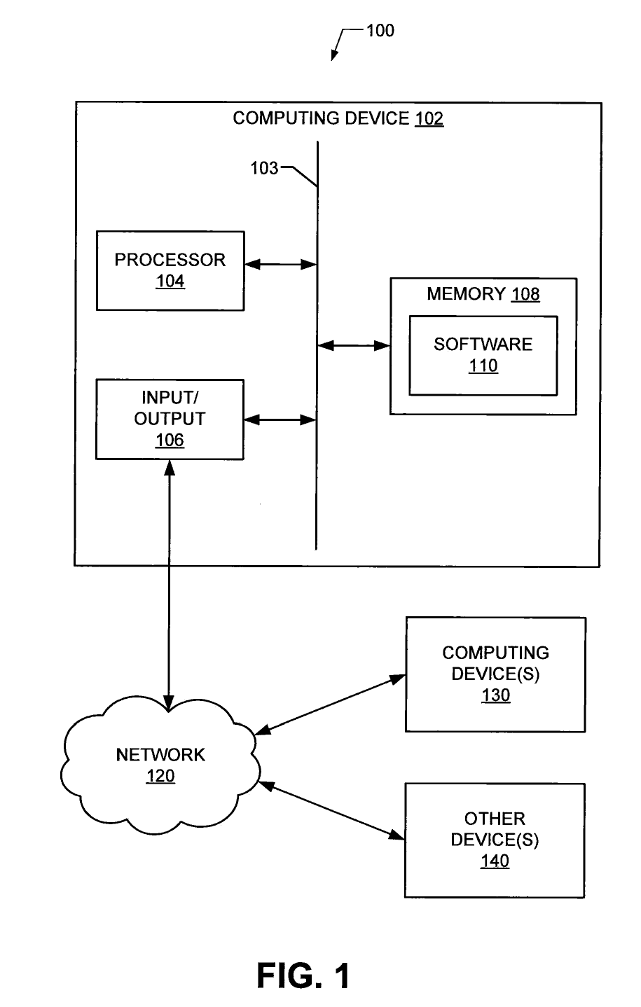

Turning now to the drawings in greater detail, wherein like reference numerals indicate like elements, FIG. 1 illustrates an example of a computer system 100 including an exemplary computing device (“computer”) 102 configured for communicating collaborative software development information. In addition to computing device 102, exemplary computer system 100 includes network 120, computing device(s) 130, and other device(s) 140. Network 120 connects computing device 102, computing device(s) 130, and other device(s) 140 and may include one or more wide area networks (WANs) and/or local area networks (LANs) such as the Internet, intranet(s), and/or wireless communications network(s). Computing device(s) 130 may include one or more other computing devices, e.g., that are similar to computing device 102 and which, e.g., may operate as server devices or client devices within computer system 100. Other device(s) 140 may include one or more other computing devices, e.g., one or more storage devices, databases, etc. Computing device 102, computing device(s) 130, and other device(s) 140 are in communication via network 120, e.g., to communicate data between them.

Exemplary computing device 102 includes processor 104, input/output component(s) 106, and memory 108, which are in communication via bus 103. Processor 104 may include multiple (e.g., two or more) processors, which may, e.g., implement pipeline processing, and may also include cache memory (“cache”) and controls (not depicted). The cache may include multiple cache levels (e.g., L1, L2, etc.) that are on or off-chip from processor 104 (e.g., an L1 cache may be on-chip, an L2 cache may be off-chip, etc.). Input/output component(s) 106 may include one or more components that facilitate local and/or remote input/output operations to/from computing device 102, such as a display, keyboard, modem, network adapter, ports, etc. (not depicted). Memory 108 includes software 110 configured for communicating collaborative software development information, which is executable, e.g., by computing device 102 via processor 104. Software 110 may be, e.g., an integrated development environment (“IDE”), part of an IDE, or in communication with an IDE to communicate collaborative software development information. Memory 108 may include other software, data, etc. (not depicted).

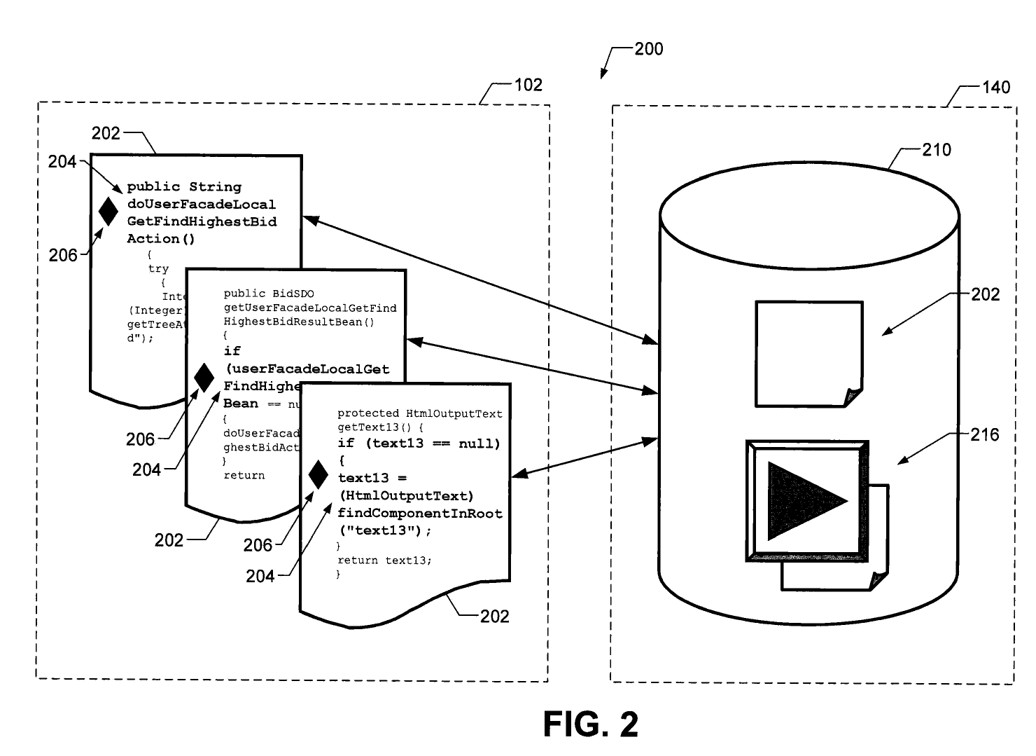

FIG. 2 illustrates an example of a subsystem 200 of the exemplary computer system 100 of FIG. 1 that is configured for communicating collaborative software development information. Exemplary subsystem 200 includes one or more files of software code 202, which may be accessible via exemplary computer 102. For example, software code 202 may be accessible via an IDE (e.g., software 110) executed on computer 102 (IDE 110 or other similar IDEs may be executed on other computing device(s) 130). Each file of software code 202 may include one or more lines of code text (e.g., one or more letters, words, numbers, symbols, etc.) and software code 202 may be “developed” (e.g., modified, such as added to, deleted from, or otherwise changed; tested; etc.), e.g., by a software developer (or other user) using the IDE 110 on computer 102. Developed software code 204 is indicated among software code 202 by emphasized code text (e.g., text that is bolded, colored, highlighted, or otherwise modified from the normal format to indicate the software has been developed). Additionally, information 216 (e.g., via audio, video, graphics, etc.) about developed software code 204 (e.g., collaborative software development information) is accessible via one or more indicators 206 (e.g., an icon, hyperlink, or other selectable indicator). Indicators 206 may be provided within a proximity (e.g., proximate, adjacent, etc.) to developed software 204 so that it is apparent to someone who views the developed software 204 (such as a collaborating software developer) that the indicators 206 correspond to the developed software 204. In some embodiments, developed software code 204 and indicators 206 may be integrated or combined so that, e.g., a developer can access information 216 by selecting or otherwise interacting with developed software code 204.

Exemplary subsystem 200 also includes storage device 210, which may be a software code server, repository, warehouse, etc. or a part thereof. Storage device 210 may, e.g., be one or more of other device(s) 140 in computer system 100. Storage device 210 may store the one or more files of software code 202 so that they are accessible, e.g., by one or more collaborating software developers at one or more different locations (e.g., distributed across one or more time zones) via IDE 110 or other IDEs (e.g., using computer 102 and/or computing device(s) 130). Storage device 210 may also store information 216 about developed software 204 that is accessible via indicators 206, e.g., also, e.g., by one or more collaborating software developers. Information 216 may include one or more messages (e.g., audio, video, etc.) and/or graphics (e.g., diagrams, drawings, etc.—“graphical data”). Information 216 is related to developed software 204; e.g., it may explain, describe, document, inquire about, etc. developed software 204, and in some embodiments may also be similarly related to software code 202 in general. Communication of software code 202 and information 216 between computer 102 (or computing device(s) 130) and storage device 210 may occur via network 120 as discussed above. Furthermore, storage device 210 may include a single component or a plurality of components (e.g., one or more databases, devices, servers, etc.). An exemplary operation of subsystem 200 will be described below.

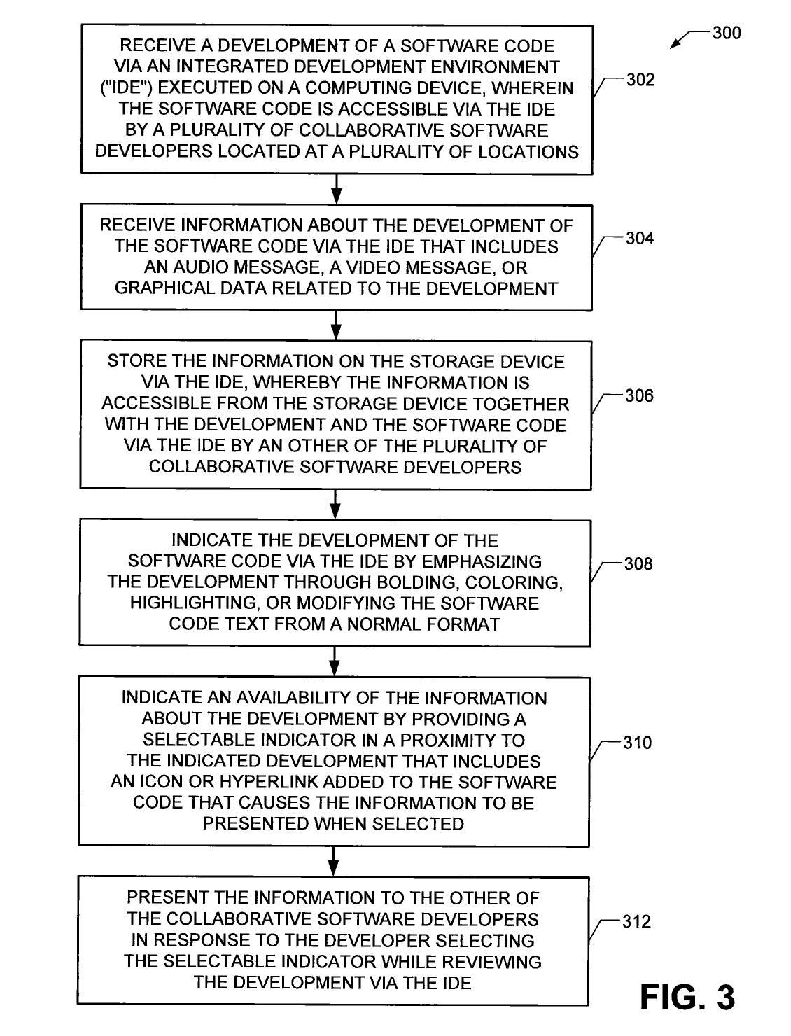

FIG. 3 illustrates an example of a method 300 for communicating collaborative software development information, which is executable, for example, on the exemplary computing device 102 of FIG. 1 (e.g., as a computer program product). Exemplary method 300 also describes an exemplary operation of subsystem 200. In block 302, a development of a software code (e.g., software code 202) is received via an integrated development environment (“IDE”—e.g., software 110) executed on a computing device (e.g., computer 102) from one of a plurality of collaborative software developers who are located at a plurality of locations, wherein the software code is accessible via the IDE by the plurality of collaborative software developers. The development includes, e.g., an addition, deletion, change, and/or test of the software code (e.g., developed software code 204). The software code includes one or more lines of code text saved in one or more files stored on a storage device (e.g., storage device 210) that is accessible via the IDE by the plurality of collaborative software developers. In some embodiments, where the development occurs in software code saved in more than one file and/or more than one location within in a file (e.g., where related, dependent, etc. changes are made to more than one portion of code), these multiple development occurrences are tracked via the IDE for future reference (e.g., as will be discussed below).

In block 304, information about the development of the software code (e.g., information 216) is received via the IDE that includes an audio message, a video message, or graphical data related to (e.g., that explains, describes, documents, inquires about, etc.) the development. The information can be associated (linked, related, etc.) with the development, and in embodiments where there are multiple development occurrences (e.g., as discussed above for block 302), the information can be associated with some or all of the occurrences (e.g., in more than one file and/or location) based on the tracking of the multiple development occurrences. In some embodiments, the information (e.g., the audio message, video message, or graphical data) may be created using another program and then transferred (imported, accessed, etc.) to the IDE. In block 306, the information is stored on the storage device via the IDE, whereby the information is accessible from the storage device together with the development and the software code via the IDE by an other of the plurality of collaborative software developers. In block 308, the development of the software code is indicated via the IDE by emphasizing the development through bolding, coloring, highlighting, or modifying the software code text from a normal format. The emphasis indicates the development to one or more of the collaborative software developers, e.g., when viewing the software code via the IDE. In some embodiments, the emphasized code text may later be restored to the normal code text format, e.g., once the development no longer needs to be indicated (e.g., once it is accepted, completed, etc.). Furthermore, in embodiments where there are multiple development occurrences (e.g., as discussed above for block 302), the development of the software code is indicated by emphasizing each occurrence (e.g., in more than one file and/or location) based on the tracking of the multiple development occurrences.

In block 310, an availability of the information about the development is indicated by providing a selectable indicator (e.g., indicator 206) in a proximity (e.g., proximate, adjacent, etc.) to the indicated development via the IDE that includes a selectable icon or hyperlink added to the software code that causes the information to be presented when selected. In some embodiments, the indicator may later be removed from the software code, e.g., once the information about the development is no longer needed (e.g., once the development is accepted, completed, etc.). Furthermore, in embodiments where there are multiple development occurrences (e.g., as discussed above for block 302), the availability of the information is indicated by adding a selectable indicator to the software code in a proximity to each occurrence (e.g., in more than one file and/or location) based on the tracking of the multiple development occurrences. In block 312, the information is presented to the other of the collaborative software developers in response to the developer selecting the selectable indicator while reviewing the development via the IDE. For example, depending on the form of the information (e.g., audio, video, and/or graphical), the information is played, displayed, etc. to the developer when the indicator is selected, e.g., via the IDE using the computing device (e.g., computer 102 or computing device(s) 130), thereby providing information related to the development to the developer while viewing the development. In some embodiments, the information may be, e.g., presented in a pop-up window and/or via another program such as an audio and/or video player or a graphic display-capable program to which the information is transferred (exported, accessed, etc.).

The following is an exemplary scenario involving collaborative development of software code in accordance with exemplary method 300:

a) A developer logs in to an IDE;
b) The developer modifies one or more lines of software code within one or more files to complete a development task via the IDE;
c) The developer determines the need to communicate information about the modification to a collaborating developer who is located in a different time zone having a significant time difference (e.g., 10 to 12 hours) and, therefore, creates an audio, video, or graphical data message describing information about the modification such as the changes made, the reason for the changes, and instructions on how to proceed with the development of the software code;
d) The IDE gives the developer the option to associate the message with all or some of the lines of code that has been modified;
e) The IDE gives the developer the option to apply access restrictions to the associated message;
f) The IDE uploads the message and stores it on the storage server with the modified software code files;
g) The IDE highlights the modified lines of code to which the message is associated and also inserts an icon in the software code text adjacent to the modified lines of code with a hyperlink to the message;
h) The developer logs out of the IDE;
i) A collaborating developer logs in to the IDE;
j) The collaborating developer opens one or more of the software code files via the IDE to work on them and is notified by the highlighting that the lines of code have been modified by the other developer;
k) The collaborating developer accesses the highlighted lines of code with the message icon via the IDE;
l) The collaborating developer selects the icon to access the message associated with the modified code by the other developer;
m) The collaborating developer works on the software code based on the message from the other developer.

The following is an exemplary scenario involving collaborative testing and troubleshooting of software code in accordance with exemplary method 300:

a) A collaborating developer (e.g., a tester) runs one or more tests on software code developed by another developer via an IDE, and the testing fails;
b) The collaborating developer determines the need to communicate information about the failed testing to the other developer who is located in a different time zone having a significant time difference (e.g., 10 to 12 hours) and, therefore, creates an audio, video, or graphical data message describing information about the failed testing such as the details of the testing, the parameters used to conduct the testing, and the point(s) of failure of the testing in the software code;
c) The collaborating developer logs in to the IDE to associate the message with one or more lines of the tested software code;
d) The IDE gives the collaborating developer the option to associate the message with the one or more lines of tested software code;
e) The IDE gives the collaborating developer the option to apply access restrictions to the associated message;
f) The IDE uploads the message and stores it on the storage server with the tested software code;
g) The IDE highlights the tested lines of code to which the message is associated and also inserts an icon in the code text adjacent to the tested lines of code with a hyperlink to the message;
h) The collaborating developer logs out of the IDE;
i) The other developer logs in to the IDE;
j) The developer opens one or more of the software code files via the IDE to work on them and is notified by the highlighting that the software code has failed testing conducted by the collaborating developer;
k) The developer accesses the highlighted lines of code with the message icon via the IDE;
l) The developer selects the icon to access the message associated to the modified code by the other developer;
m) The developer works on the software code to resolve the causes of the failed testing based on the message from the collaborating developer.

Exemplary computer system 100, computing device 102, and subsystem 200 are illustrated and described with respect to various components, modules, etc. for exemplary purposes. It should be understood that other variations, combinations, or integrations of such elements that provide the same features, functions, etc. are included within the scope of embodiments of the invention.

The flow diagram described herein is just an example. There may be many variations to this diagram or the blocks (or operations) thereof without departing from the spirit of embodiments of the invention. For instance, the blocks may be performed in a differing order, or blocks may be added, deleted or modified. All of these variations are considered a part of the claimed invention. Furthermore, although an exemplary execution of the flow diagram blocks is described with respect to the exemplary computer system 100, computing device 102, and subsystem 200, execution of the flow diagram blocks may be implemented with other hardware and/or software architectures that provide the same features, functions, etc. in accordance with exemplary embodiments of the invention.

Exemplary embodiments of the invention can be implemented in hardware, software, or a combination of both. Those embodiments implemented in software may, for example, include firmware, resident software, microcode, etc. Exemplary embodiments of the invention may also be implemented as a computer program product accessible from a computer-usable or computer-readable medium providing program code for use by or in connection with a computer or other instruction execution system. In this regard, a computer-usable or computer-readable medium can be any apparatus that can contain, store, communicate, propagate, or transport the program for use in connection with the instruction execution system, apparatus, or device.

The computer-usable or computer-readable medium can be an electronic, magnetic, optical, electromagnetic, infrared, or semiconductor system (apparatus, device, etc.) or a propagation medium. Examples of a computer-readable medium include a semiconductor or solid state memory, magnetic tape, a removable computer diskette, a random access memory (RAM), a read-only memory (ROM), a rigid magnetic disk, or an optical disk. Some current examples of optical disks include compact disk-read only memory (CD-ROM), compact disk-read/write (CD-R/W), or digital video disk (DVD).

A data processing system suitable for storing and/or executing program code can include at least one processor coupled directly or indirectly to memory elements through a system bus. The memory elements can include local memory employed during actual execution of the program code, bulk storage, or cache memories that provide temporary storage of at least some program code to reduce the number of times the code needs to be retrieved from bulk storage during execution.

Input/output (I/O) devices (e.g., keyboards, displays, pointing devices, etc.) can be coupled to the data processing system either directly or through intervening I/O controllers. Network adapters may also be coupled to the data processing system to allow the system to be coupled to other data processing systems or remote printers or storage devices through intervening private or public networks. Telephonic modems, cable modems, and ethernet cards are a few examples of the currently available types of network adapters.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

1. A method for communicating collaborative software development information, comprising:
receiving a development of a software code via an integrated development environment executed on a computing device from one of a plurality of collaborative software developers who are located at a plurality of locations, wherein:
the development comprises at least one of an addition, deletion, change, or test of the software code by the one of the plurality of software developers via the integrated development environment; and
the software code comprises at least one line of code text saved in at least one file stored on a storage device that is accessible via the integrated development environment by the plurality of collaborative software developers;
receiving information about the development of the software code via the integrated development environment from the one of the plurality of software developers, wherein the information comprises at least one of an audio message, a video message, or graphical data created by the one of the plurality of software developers that explains, describes, documents, or inquires about the development;
storing the information on the storage device via the integrated development environment, whereby the information is accessible from the storage device together with the development and the software code via the integrated development environment by an other of the plurality of collaborative software developers who are located at the plurality of locations;
logging out of the integrated development environment by the one of the plurality of collaborative software developers;
logging on to the integrated development environment by the other of the plurality of software developers;
indicating the development of the software code to the other of the plurality of collaborative software developers by emphasizing the development via the integrated development environment, wherein emphasizing the development comprises at least one of bolding, coloring, highlighting, or modifying the code text of the development from a normal format of the code text to indicate that the code text has been developed;
indicating an availability of the information about the development to the other of the plurality of collaborative software developers in a proximity to the indicated development via the integrated development environment, wherein indicating the availability of the information comprises adding a selectable indicator to the software code proximate to or integrated with the indicated development that includes at least one of a selectable icon or hyperlink, the selection of which causes the information to be presented via the integrated development environment while reviewing the development; and
presenting the information to the other of the plurality of collaborative software developers who are located at the plurality of locations, wherein the information is presented in response to the other of the plurality of collaborative software developers selecting the selectable indicator while reviewing the development via the integrated development environment.
